(19) United States
(12) Patent Application Publication
(10) Pub. No.: US 2016/0096485 A1
(43) Pub. Date: Apr. 7, 2016

(54) CLAMPING APPARATUS WITH AUXILIARY MIRROR

(71) Applicant: Eagle FAN, Chu-Pei City (TW)

(72) Inventor: Eagle FAN, Chu-Pei City (TW)

(21) Appl. No.: 14/504,598

(22) Filed: Oct. 2, 2014

(51) Int. Cl. B60R 11/02; B60R 1/04

(52) U.S. Cl. CPC B60R 11/02; B60R 1/04; B60R 2011/0033

(57) ABSTRACT

A clamping apparatus with auxiliary mirror is provided, including a first clamping unit, an auxiliary minor, a first adjustable connection unit, and a second clamping unit; wherein the first clamping unit for clamping to a rear-view minor of a car; the auxiliary minor being disposed at the first clamping unit; the first adjustable connection unit for connecting the first clamping unit and the second clamping unit, and able to adjust a position and an angle of the second clamping unit with respect to the first clamping unit; the second clamping unit including two clamping elements with adjustable clamping width to clamp an electronic device. As such, the auxiliary mirror can provide a viewing angle different from the rear-view mirror to improve driving safety.

### TECHNICAL FIELD

The technical field generally relates to a clamping apparatus, and in particular to a clamping apparatus to be disposed at a rear-view mirror inside a vehicle, for clamping a portable electronic device, and having an auxiliary mirror to enhance safety.

### BACKGROUND

It is easy for a driver to observe and handle the situations occurring in the visible area in front of the car, but more difficult for the driver to stay completely aware of the situation occurring in the areas on the side or behind the car. The driver must rely on the rear-view minor, and even so, the blind spots exist, for example, the area near the back seat on the passenger side, which is often referred to as B-pillar area. One solution often used is a wide-angle rear-view mirror.

The GPS or smart phone with GPS capability is one of the most common devices used in a car. Additional clamping apparatus is often disposed to hold the portable electronic device. It is desirable to devise a clamping apparatus with additional capability to enhance driving safety.

### SUMMARY

An objective of the present invention is to provide a clamping apparatus with auxiliary mirror. The clamping apparatus is able to clamp a portable electronic device to the rear-view minor inside a car, and also provides an auxiliary minor with viewing angle different from the rear-view minor, such as, to view the area near the rear passenger-side door so that the driver can stay aware of the traffic condition in target area to enhance driving safety.

To achieve the above objective, the clamping apparatus with auxiliary minor of the present invention includes a first clamping unit, an auxiliary mirror, a first adjustable connection unit, and a second clamping unit; wherein the first clamping unit for clamping to a rear-view mirror of a car; the auxiliary minor being disposed at the first clamping unit; the first adjustable connection unit for connecting the first clamping unit and the second clamping unit, and able to adjust a position and an angle of the second clamping unit with respect to the first clamping unit; the second clamping unit including two clamping elements with adjustable clamping width to clamp an object of various sizes.

In addition, the present invention further includes a second adjustable connection unit, for connecting the first clamping unit and the auxiliary mirror, and the second adjustable connection unit is able to adjust a position and an angle of the auxiliary minor with respect to the first clamping unit.

Furthermore, the auxiliary mirror of the present invention may be a wide-angle mirror, fastened to the back of the first clamping unit, located at the other side of the area clamped by the first clamping unit.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 shows a schematic view of a first embodiment of the present invention;

FIG. 2 shows a schematic side view of a first embodiment of the present invention;

FIG. 3A shows a schematic view of the movement of the first clamping unit and the second clamping unit of the first embodiment of the present invention;

FIG. 3B shows a schematic view of the adjustment of the auxiliary mirror and the second clamping unit of the first embodiment of the present invention;

FIG. 4 shows a schematic view of the present invention in actual application;

FIG. 5 shows a schematic view of a second embodiment of the present invention;

FIG. 6 shows a partial exploded view of a second embodiment of the present invention; and

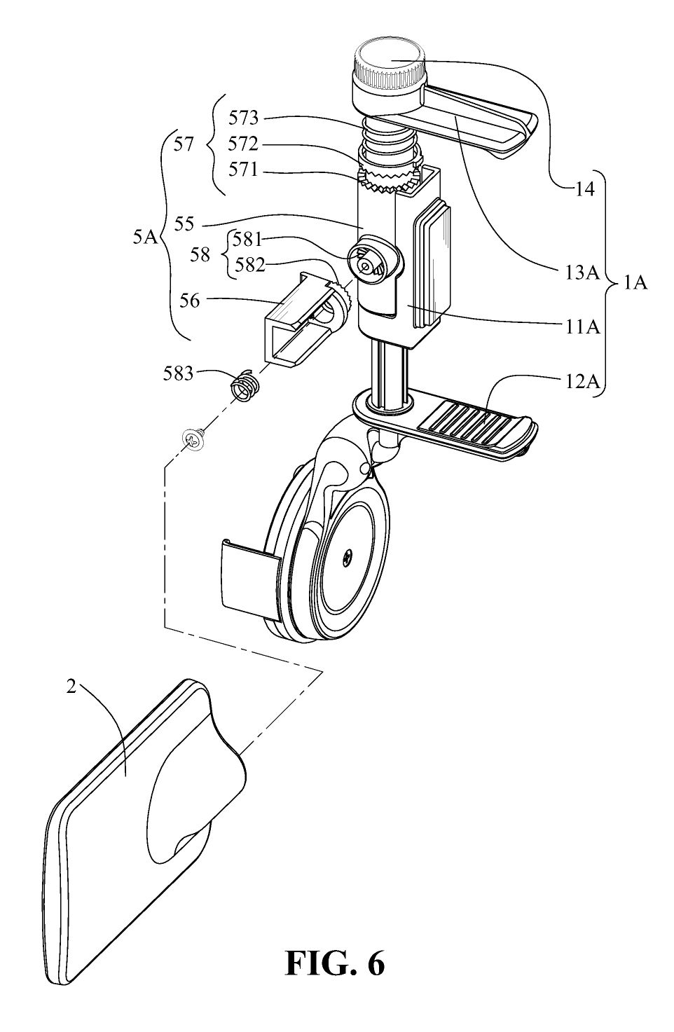

FIG. 7 shows a schematic view of a third embodiment of the present invention.

### DETAILED DESCRIPTION OF THE DISCLOSED EMBODIMENTS

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

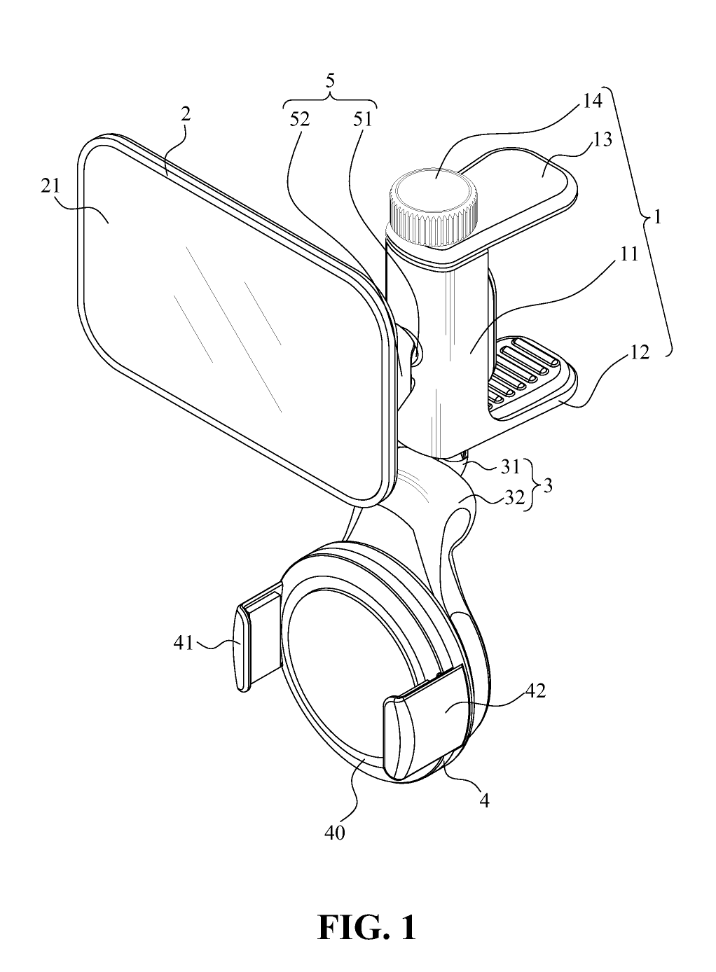

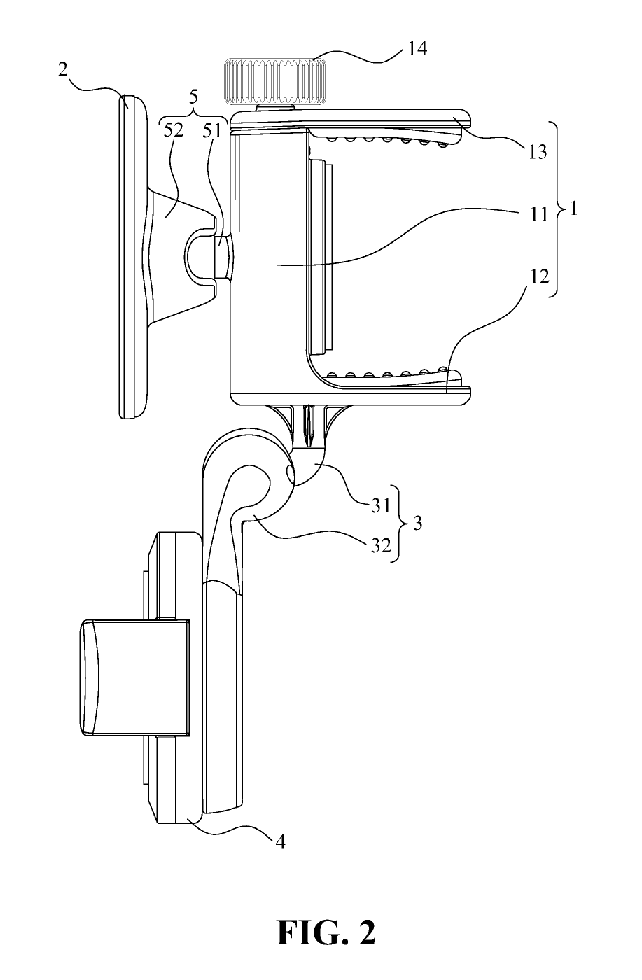

FIG. 1 and FIG. 2 show a schematic view and a side view of a first embodiment of the present invention respectively. The clamping apparatus with auxiliary minor includes a first clamping unit 1, an auxiliary minor 2, a first adjustable connection unit 3, and a second clamping unit 4. The first clamping unit 1 is for clamping to a rear-view mirror of a car. The auxiliary minor 2 is disposed at the first clamping unit 1. The first adjustable connection unit 3 is for connecting the first clamping unit 1 and the second clamping unit 4, and is able to adjust a position and an angle of the second clamping unit 4 with respect to the first clamping unit 1. The second clamping unit 4 includes two clamping elements 41, 42 with adjustable clamping width to clamp an object of various sizes, such as, smart phone or GPS navigator. As such, the clamping apparatus can clamp onto the object and fasten to the rear-view mirror, with the auxiliary minor 2 to provide additional viewing range so as to improve driving safety.

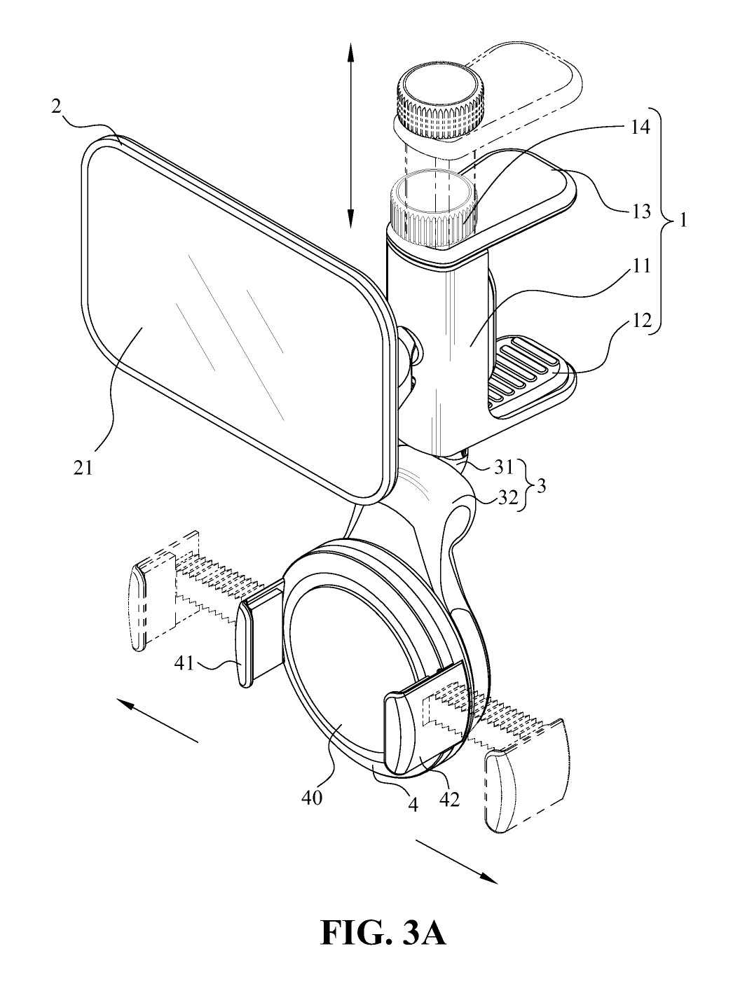

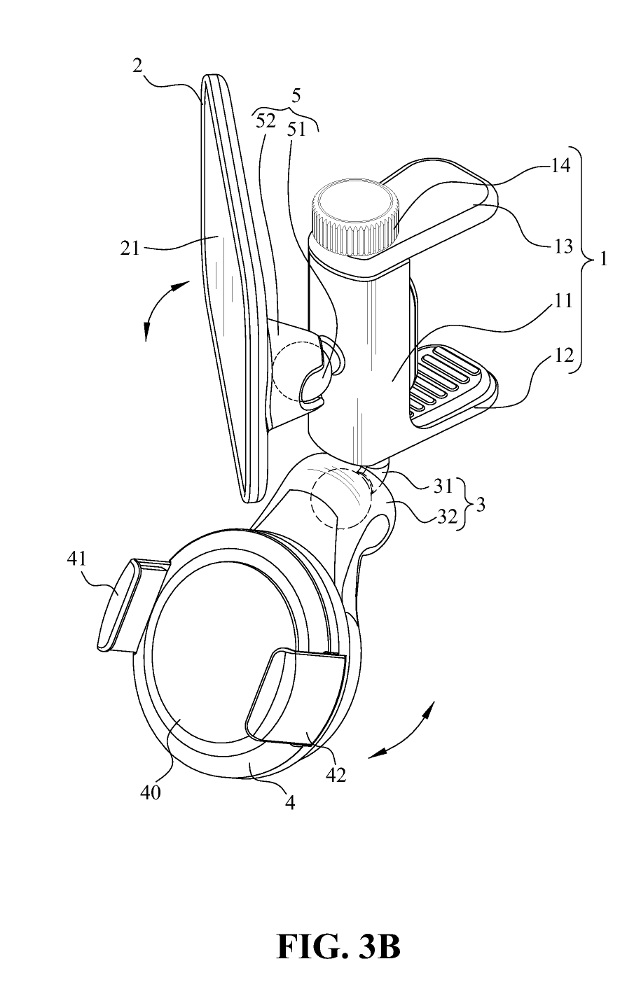

The following describes the structure of the present invention in details. The first clamping unit 1 is for fastening to the mirror side of the rear-view mirror and allows the auxiliary mirror 2 to provide a viewing area different from the mirror. The first clamping unit 1 can be realized by various structures. The following embodiment is only for illustrative purpose, instead of restrictive. The first clamping unit 1 includes a first base body 11, a first clamping element 12 and the second clamping element 13, disposed oppositely, and a control knob 14. Referring to FIG. 3A, the first clamping element 12 is fastened to the first base body 11, and the second clamping element 13 is able to move linearly through the control of the control knob 14 so that the second clamping element 13 is able to move towards or away from the first clamping element 12. The first clamping element 12 and the second clamping element 13 can clamp onto the frame of the rear-view mirror so that the clamping apparatus is fastened to the rear-view minor.

The auxiliary minor 2 is disposed at the first clamping unit 1. The position and the angle of the auxiliary minor 2 can be adjustable or non-adjustable. The non-adjustable embodiment will be described later. The present embodiment describes the adjustable embodiment. A second adjustable connection unit 5 is disposed between the auxiliary minor 2 and the first clamping unit 1. For multi-directional adjustment, a ball-based connection structure with suitable tightness is used. The structure includes at least a ball-shaped connection element 51 and a carrier base 52 (as shown in FIG. 3B). The connection element 51 is disposed at the back of the first base body 11, and the carrier base is disposed at the back of the auxiliary minor 2. The carrier base 52 carries the ball-shape end of the connection element 51 so that the connection element 51 and the carrier base 52 cannot be disengaged and allows multi-directional adjustment. This structure is widely known in conventional technique, and the detailed description is omitted here. As such, the position and the angle of the auxiliary minor 2 can be adjusted with respect to the first clamping unit in various directions. The auxiliary mirror 2 includes a mirror surface 21. In the present embodiment, the minor surface 21 is a flat minor. However, other minors, such as convex-spherical wide-angle mirror can also be used.

The second clamping unit 4 is for clamping an object, in particular, a portable electronic device, such as, a GPS or a smart phone with GPS navigation capability, and so on. The clamping structure is also widely known in conventional technique, and the present embodiment describes one of the structures. The second clamping unit 4 at least includes a second base body 40 and two clamping elements 41, 42. The clamping width of the two clamping elements 41, 42 is adjustable to clamp onto electronic devices of different widths.

The first adjustable connection unit 3 is connected to the first clamping unit 1 and the second connection unit 4 so that the positions of the two clamping units can be adjusted. The structure can also be realized in various types. The present invention describes only a few of the possible implementations. The first adjustable connection unit 3 can be a coupling structure with suitable tightness. As such, the adjustment can be conducted along a single axial direction. On the other hand, for multi-directional adjustment, a ball-shaped connection structure with suitable tightness is used. The structure includes at least a ball-shaped connection element 31 and a carrier base 32. The connection element 31 is disposed at the back of the first base body 11, and the carrier base 32 is disposed at the back of the second base body 40. The carrier base 32 carries the ball-shape end of the connection element 31 so that the connection element 31 and the carrier base 32 cannot be disengaged and allows multi-directional adjustment.

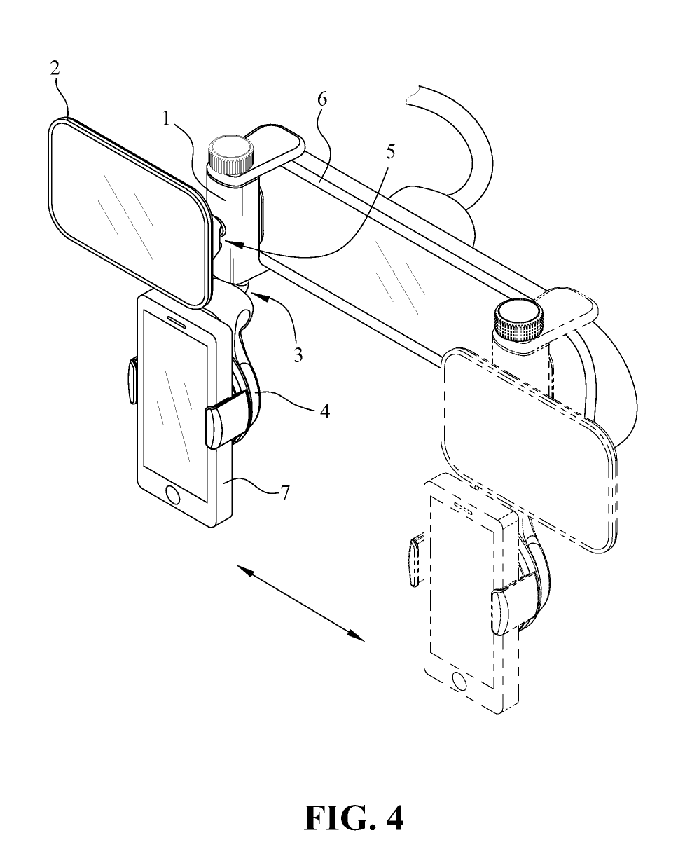

FIG. 4 shows a schematic view of the present invention in actual application. The clamping apparatus with auxiliary minor of the present invention uses the first clamping unit 1 to clamp onto the frame of the rear-view minor 6 of a car, and the second clamping unit 4 clamps onto a smart phone 7. The smart phone 7 provides the GPS navigation capability. The first adjustable connection unit 3 is able to adjust the angle and position of the second clamping unit 4 so that the smart phone 7 will face the user directly. The auxiliary mirror 2 uses the second adjustable connection unit 5 to adjust the viewing angle so that the user can view the area outside the rear passenger side to improve driving safety. Also in FIG. 4, a dash-line drawing of a clamping apparatus is included to indicate an alternative deployment location for the clamping apparatus. Similarly, the auxiliary mirror 2 can also be adjusted up to 180°. As such, the present invention can be used in any car with the driver seat on either left side or right side.

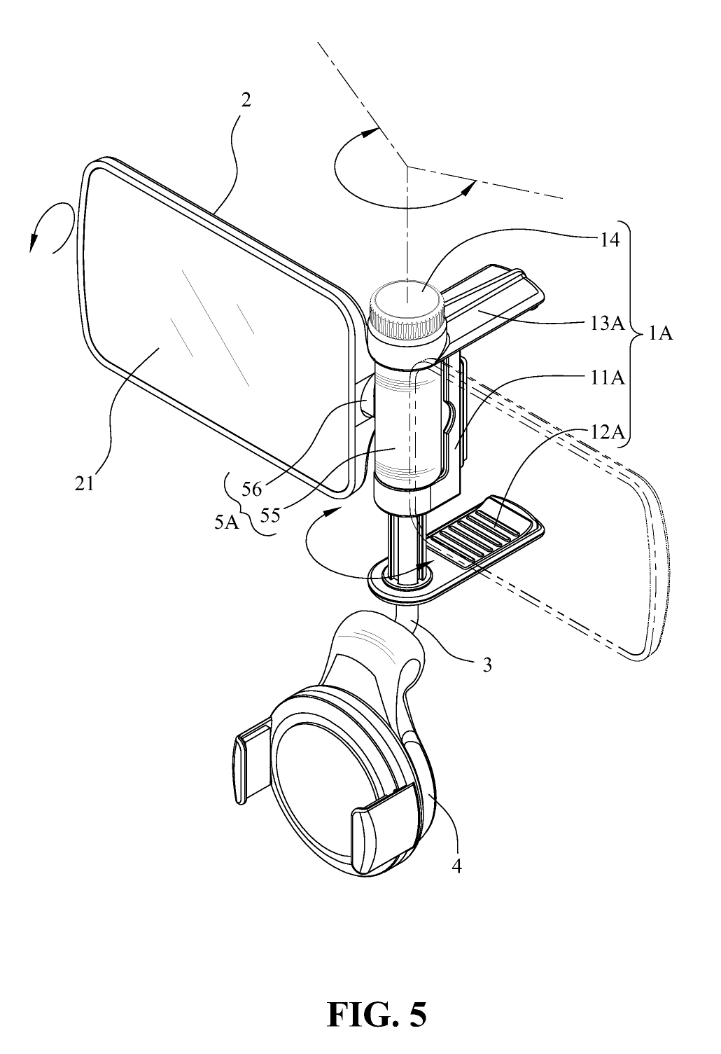

FIG. 5 shows a second embodiment of the present invention. In the present embodiment, the position and angle of the auxiliary mirror 2 are also adjustable, but the structure of the second adjustable connection unit 5A is different from the earlier embodiment. The second adjustable connection unit 5A in the present embodiment is a coupling structure with a suitable tightness, in combination with a rotatable axial-connection structure. As shown in FIG. 5, the structure includes a coupling tube 55 and an axial connection element 56. The coupling tube 55 is coupled to the first base body 11A of the first clamping element 1A, and the axial connection element 56 is connected to the outer wall of the coupling tube 55 at one end, and connected to the auxiliary mirror 2 at the other end. The coupling structure allows the auxiliary mirror 2 to change the position through rotation within a 210° range, and the axial connection structure allows the auxiliary minor 2 to rotate 360° around the axis. As such, regardless that the auxiliary minor 2 is disposed on the left side or right side, the mirror surface 21 can always be adjusted to face the user.

The operation and structure of the first clamping unit 1A are also slightly different from the earlier embodiment. The structure includes a first base body 11A, a first clamping element 12A, a second clamping element 13A and a control knob 14. However, in the present embodiment, the second clamping element 13A moves synchronously with the first base body 11A, and the first clamping element 12A moves linearly by the control of the control knob 14 so that the first clamping element 12A can move towards or away from the second clamping element 13A.

In the present embodiment, after the coupling tube 55 and the axial connection element 56 of the second adjustable connection unit 5A are rotated for adjustment, an additional locking structure may be used to fasten the position. Therefore, the second adjustable connection unit 5A further includes a first locking assembly 57 and a second locking assembly 58. The coupling tube 55 is coupled to the first base body 11A, rotatable with a 210° range and mainly rotatable in the non-clamping area of the first base body 11A. The axial connection element 56 is connected to the auxiliary mirror 2, with one end axially connected to the outer wall of the coupling tube 55. The axial connection element 56 rotates around an axis perpendicular to the rotation axis of the coupling tube 55. The first locking assembly 57 is to fasten the position after adjustment of the coupling tube 55 and the first base body 11A. The first locking assembly 57 includes a ring-teeth part 571, a movable ring-teeth element 572 and a spring 573. The ring-teeth part 571 is disposed at the tube wall at the top of the coupling tube 55. The movable ring-teeth element 572 is able to move linearly up and down in a small distance, with ring-teeth corresponding to the ring-teeth part 571. The spring 573 contacts the movable ring-teeth element 572. With no external force present, the movable ring-teeth element 572 engages the ring-teeth part 571 under the effect of the spring 573. When the coupling tube 55 is rotated by an external force, the movable ring-teeth element 572 overcomes the force of the spring 573 and moves upwards so as to achieve the function of adjusting and fastening the angle of the coupling tube 55.

The second locking assembly 58 is for fastening the angle of the auxiliary minor 2 after adjustment. The second locking assembly 58 includes a first teeth surface 581, a second teeth surface 582 and a spring 583. The first teeth surface 581 is disposed on the outer wall of the coupling tube 55, and the second teeth surface 582 is disposed on the end surface of the axial connection element 56. The spring 583 provides a force for the second teeth surface 582 to maintain contact with the first teeth surface 581. However, with the presence of an external force, the axial connection element 56 can still move linearly to disengage from the teeth surface. As such, when the auxiliary mirror 2 is rotated for angle adjustment, the second teeth surface 582 on the axial connection element 56 engages with the first teeth surface 581 to fasten the position of the auxiliary minor 2. The locking mechanism between the coupling structure and the axial connection structure is only illustrative, instead of restrictive.

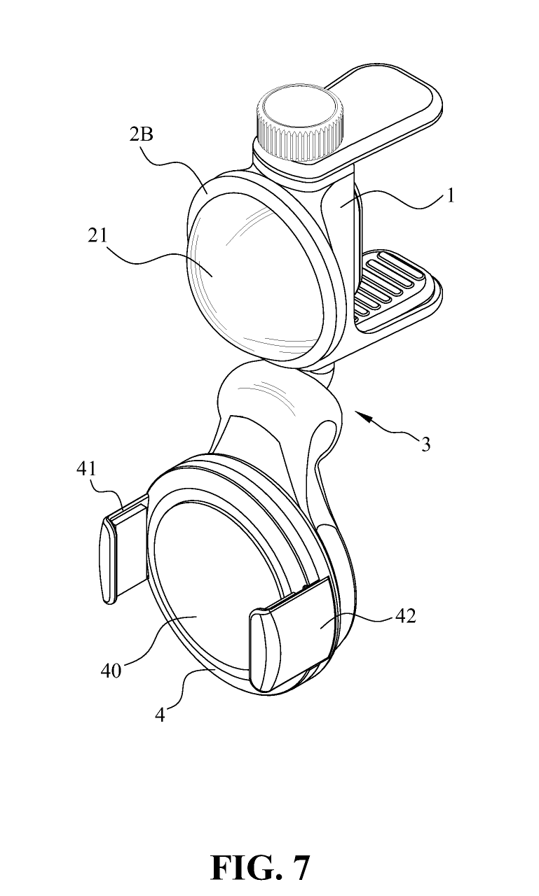

FIG. 7 shows a third embodiment of the present invention. The clamping apparatus includes a first clamping unit 1, an auxiliary mirror 2, a first adjustable connection unit 3 and a second clamping unit 4. However, in the present embodiment, the auxiliary minor 2 is fastened to the back of the first clamping unit 1, and is non-adjustable. The mirror surface 21 of the auxiliary mirror 2 is a convex-spherical wide-angle mirror. As such, the auxiliary mirror 2 can provide a viewing angle different from the rear-view minor. When the clamping apparatus with auxiliary minor is installed at the rear-view mirror inside a car, the clamping apparatus can clamp onto an electronic device as well as provides an additional viewing area to the user to improve driving safety.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A clamping apparatus with auxiliary mirror, comprising:
a first clamping unit, for clamping onto a rear-view mirror inside a car;
an auxiliary mirror, disposed at the first clamping unit;
a first adjustable connection unit, connected to the first clamping unit and a second clamping unit to adjust the angle and position of the second clamping unit with respect to the first clamping unit; and
a second clamping unit, further comprising two clamping elements with adjustable clamping width to clamp an object of various sizes.

2. The clamping apparatus with auxiliary mirror as claimed in claim 1, wherein the first adjustable connection unit is a coupling structure with tightness.

3. The clamping apparatus with auxiliary mirror as claimed in claim 1, wherein the first adjustable connection unit is a ball-shaped connection structure able for multi-angle adjustment.

4. The clamping apparatus with auxiliary mirror as claimed in claim 1, further comprising a second adjustable connection unit, connecting to the first clamping unit and the auxiliary minor, and able to adjust the angle of the auxiliary mirror with respect to the first clamping unit.

5. The clamping apparatus with auxiliary minor as claimed in claim 4, wherein the second adjustable connection unit is a ball-shaped connection structure able for multi-angle adjustment.

6. The clamping apparatus with auxiliary minor as claimed in claim 4, wherein the auxiliary minor comprises a flat mirror surface or a convex-spherical wide-angle minor surface.

7. The clamping apparatus with auxiliary minor as claimed in claim 4, wherein the second adjustable connection unit comprises a coupling tube and an axial connection element, the coupling tube is coupled to the first clamping unit and the axial connection element is axially connected to the coupling tube at outer wall, and the auxiliary minor is connected to the axial connection element.

8. The clamping apparatus with auxiliary minor as claimed in claim 1, wherein the auxiliary minor is fastened to the back of the first clamping unit.

9. The clamping apparatus with auxiliary minor as claimed in claim 8, wherein the auxiliary minor comprises a convex-spherical wide-angle mirror surface.
